(19) United States
(12) Patent Application Publication
(10) Pub. No.: US 2009/0110113 A1
(43) Pub. Date: Apr. 30, 2009

(54) Wireless Communication Systems, Apparatus and Method for Encoding and Decoding a Plurality of Information Bits

(75) Inventors: Wen-Rong Wu, Hsinchu City (TW); Shih-Chi Shen, Sindian City (TW); Yu-Cheng Lin, Xizhi City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: NATIONAL CHIAO TUNG UNIVERSITY, Hsinchu City (TW)

(21) Appl. No.: 12/169,295

(22) Filed: Jul. 8, 2008

(30) Foreign Application Priority Data
Oct. 29, 2007 (TW) 96140572

(51) Int. Cl. H04L 27/00

(52) U.S. Cl. 375/298; 375/295; 375/341

(57) ABSTRACT

Wireless transmitted system and apparatus and method for encoding a plurality of information bits to a plurality of transmitted signals thereof, and wireless received system and apparatus and method for decoding a received signal to a plurality of information bits thereof are provided. The wireless transmitted system encodes a plurality of information bits to a plurality of transmitted signals by two logic operation modules, an interleaving module, and a combination module. The wireless received system decodes a received signal to a plurality of information bits by a division module, two probability generation modules, two status calculation modules, a signal generation module and a combination module.

This application claims the benefit of priority based on Taiwan Patent Application No. 096140572 filed on Oct. 29, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a wireless communication system for transmission and an apparatus and a method for encoding a plurality of information bits into a plurality of transmitted signals thereof, as well as a wireless communication system for receiving and an apparatus and a method for decoding a received signal into a plurality of information bits thereof. More particularly, the present invention relates to encoding a plurality of information bits into a plurality of transmitted signals in a wireless communication system for transmission and decoding a received signal into a plurality of information bits in a wireless communication system for receiving by using improved Turbo codes.

2. Descriptions of the Related Art

In a Multi-Input Multi-Output (MIMO) Orthogonal Frequency Division Multiplexing (OFDM) wireless communication system, technique of the tone-interleaved coded modulation (TICM) is used to decrease computational complexity of decoding operations. TICM adopts a symbol block as a unit of interleaved information bits, wherein the symbol block contains all symbols transmitted in a single tone. As the soft-bit demapping has already been considered in a branch metric calculator, operations of the TICM do not have to perform the soft-bit demapping and consequently, computational complexity of decoding operations is decreased.

Because TICM simply uses a channel encoder for encoding, a significant improvement in performance can only be obtained when a channel response is short. When the channel response becomes longer, the improvement in performance will become unobvious due to the fading in the channel frequency response and the lack of good tolerance for bursty bit errors of the block interleaver.

Accordingly, it is highly desirable in the art to provide improved TICM in an MIMO OFDM wireless communication system, so as to reduce occurrence of bursty bit errors and improve performance of the system.

### SUMMARY OF THE INVENTION

One objective of this invention is to provide a method for encoding a plurality of information bits into a plurality of transmitted signals. With this encoding method, the immunity of Turbo-Interleaved Coded Modulation (TICM) against bursty bit errors can be improved.

To this end, this method comprises the steps of: (a) applying a logic operation to a first part of the information bits and a second part of the information bits to obtain a first encoded signal; (b) combining the first part and the first encoded signal to obtain one of the transmitted signals; (c) interleaving the first part and the second part to obtain a first interleaved sub-signal and a second interleaved sub-signal; (d) applying the logic operation to the first interleaved sub-signal and the second interleaved sub-signal to obtain a second encoded signal; and (e) combining the second interleaved sub-signal and the second encoded signal to obtain another of the transmitted signals.

Another objective of this invention is to provide a method for decoding a received signal into a plurality of information bits. When the decoding method is used in conjunction with the aforesaid method, occurrence of bursty bit errors in the resulting information bits may be decreased. Therefore, the operational performance can be improved.

To this end, this method comprises the steps of: (a) dividing the received signal into a first sub-signal and a second sub-signal, wherein the first sub-signal has a plurality of first candidate values, and the second sub-signal has a plurality of second candidate values; (b) generating a first candidate probability value for each of the first candidate values according to the first sub-signal; (c) generating a second candidate probability value for each of the second candidate values according to the second sub-signal; (d) calculating a plurality of first state probability values and a plurality of first state transition probability values according to the first candidate probability values; (e) calculating a plurality of second state probability values and a plurality of second state transition probability values according to the second candidate probability values; (f) generating a first sub-resultant signal according to the first state probability values and the first state transition probability values; (g) generating a second sub-resultant signal according to the second state probability values and the second state transition probability values; and (h) combining the first sub-resultant signal and the second sub-resultant signal to generate the information bits.

Yet another objective of this invention is to provide an apparatus which, by use of the encoding method, may alleviate the shortcoming that bursty bit errors tend to occur in TICM operations, thus improving performance of the system.

To this end, this apparatus is configured to encode a plurality of information bits to a plurality of transmitted signals. The apparatus comprises a first logic operation module, an interleaving module, a second logic operation module, a first combination module, and a second combination module. The first logic operation module is configured for applying a logic operation to a first part of the information bits and a second part of the information bits to obtain a first encoded signal. The interleaving module is configured for interleaving the first part and the second part to obtain a first interleaved sub-signal and a second interleaved sub-signal. The second logic operation module is configured for applying the logic operation to the first interleaved sub-signal and the second interleaved sub-signal to obtain a second encoded signal. The first combination module is configured for combining the first part and the first encoded signal to obtain one of the transmitted signals. The second combination module is configured for combining the second interleaved sub-signal and the second encoded signal to obtain another of the transmitted signals.

Yet a further objective of this invention is to provide an apparatus which when used in conjunction with the aforesaid apparatus, may reduce occurrence of bursty bit errors when decoding a received signal into information bits, thus obtaining better performance.

To this end, this apparatus is configured to decode a received signal into a plurality of information bits. The apparatus comprises a division module, a first probability generation module, a second probability generation module, a first state calculation module, a second state calculation module, and a signal generation module. The division module is configured for dividing the received signal into a first sub-signal and a second sub-signal, wherein the first sub-signal has a plurality of first candidate values, and the second sub-signal has a plurality of second candidate values. The first probability generation module is configured for generating a first candidate probability value for each of the first candidate values according to the first sub-signal. The second probability generation module is configured for generating a second candidate probability value for each of the second candidate values according to the second sub-signal. The first state calculation module is configured for calculating a plurality of first state probability values and a plurality of first state transition probability values according to the first candidate probability values. The second state calculation module is configured for calculating a plurality of second state probability values and a plurality of second state transition probability values according to the second candidate probability values. The signal generation module is configured for generating a first sub-resultant signal according to the first state probability values and the first state transition probability values, generating a second sub-resultant signal according to the second state probability values and the second state transition probability values, and combining the first sub-resultant signal and the second sub-resultant signal to generate the information bits.

Still a further objective of this invention is to provide a wireless communication system for transmission. By use of the encoding method, this wireless communication system for transmission can alleviate the shortcoming that bursty bit errors tend to occur in TICM operations, thus improving performance of the system.

To this end, this wireless communication system for transmission comprises a processor, a first Quadrature Amplitude Modulation (QAM) mapper, a second QAM mapper, a tone-level interleaver, a parser, an inverse fast Fourier transformer, and a transmission apparatus. The processor is configured for encoding a plurality of information bits into a plurality of transmitted signals. More particularly, the processor is configured for applying a logic operation to a first part of the information bits and a second part of the information bits to obtain a first encoded signal, interleaving the first part and the second part to obtain a first interleaved sub-signal and a second interleaved sub-signal, applying the logic operation on the first interleaved sub-signal and the second interleaved sub-signal to obtain a second encoded signal, combining the first part and the first encoded signal to obtain a first transmitted signal of a plurality of transmitted signals, and combining the second interleaved sub-signal and the second encoded signal to obtain a second transmitted signal of the transmitted signals. The first QAM mapper is configured for mapping the first transmitted signal by QAM to obtain a first QAM symbol. The second QAM mapper is configured for mapping the second transmitted signal by QAM to obtain a second QAM symbol. The tone-level interleaver is configured for interleaving the first QAM symbol and the second QAM symbol to obtain an interleaved resultant signal. The parser is configured for parsing the interleaved resultant signal to obtain a plurality of sub-parsed resultant signal. The inverse fast Fourier transformer is configured for applying inverse Fourier transform to each of the sub-parsed resultant signals to obtain a plurality of wireless transmitted signals. The transmission apparatus is configured for transmitting the wireless transmitted signals.

Still another objective of this invention is to provide a wireless communication system for receiving. When the wireless communication system for receiving is used in conjunction with the aforesaid wireless communication system for transmission, may reduce occurrence of bursty bit errors when decoding a received signal into information bits, thus obtaining better performance.

To this end, this wireless communication system for receiving comprises a receiving apparatus, a fast Fourier transformer, a tone-level de-interleaver and a processor. The receiving apparatus is configured for receiving a wireless signal. The fast Fourier transformer is configured for applying fast Fourier transform to the wireless signal to obtain a transformed signal. The tone-level de-interleaver is configured for de-interleaving the transformed signal to obtain a received signal. The processor is configured for: dividing the received signal to a first sub-signal and a second sub-signal, wherein the first sub-signal has a plurality of first candidate values, and the second sub-signal has a plurality of second candidate values; generating a first candidate probability value for each of the first candidate values according to the first sub-signal; generating a second candidate probability value for each of the second candidate values according to the second sub-signal; calculating a plurality of first state probability values and a plurality of first state transition probability values according to the first candidate probability values; calculating a plurality of second state probability values and a plurality of second state transition probability values according to the second candidate probability values; generating a first sub-resultant signal according to the first state probability values and the first state transition probability values, configured for generating a second sub-resultant signal according to the second state probability values and the second state transition probability values; and combining the first sub-resultant signal and the second sub-resultant signal to generate the information bits.

In summary, this invention provides a wireless communication system for transmission and an apparatus and a method for encoding a plurality of information bits into a plurality of transmitted signals thereof, and a wireless communication system for receiving and a method for decoding a receiving signal into a plurality of information bits thereof. By use of the wireless communication system for transmission in combination with the wireless communication system for receiving, occurrence of bursty bit errors of the TICM can be reduced even in case of a long channel response, thus effectively improving performance of the system.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a first embodiment of this invention;

FIG. 1B is a detailed partial view of a processor of the first embodiment;

FIG. 2 is a schematic view of a second embodiment of this invention;

FIG. 3 is a flow chart of a third embodiment of this invention; and

FIG. 4 is a flow chart of a fourth embodiment of this invention.

### DESCRIPTION OF THE PREFERRED EMBODIMENT

Embodiments will now be described in the following to explain this invention, which relates to a wireless communication system for transmission and an apparatus and a method for encoding a plurality of information bits into a plurality of transmitted signals thereof, and a wireless communication system for receiving and a method for decoding a receiving signal into a plurality of information bits thereof. However, the scope of the present invention is limited to the specific context, applications, and/or particular methods described in these embodiments. Therefore, description of these embodiments is only intended to illustrate rather than to limit this invention. It should be noted that, in the following embodiments and attached drawings, elements unrelated to this invention are omitted from depiction.

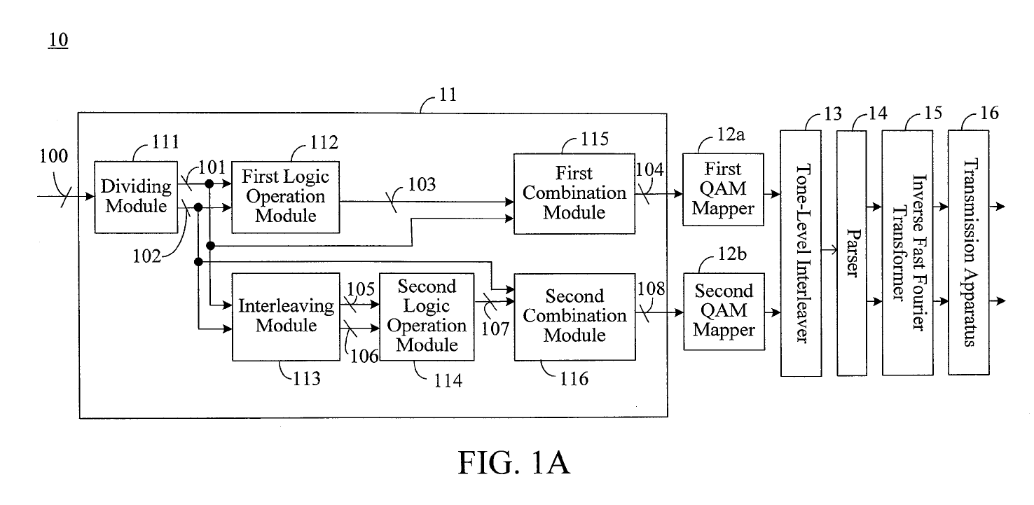

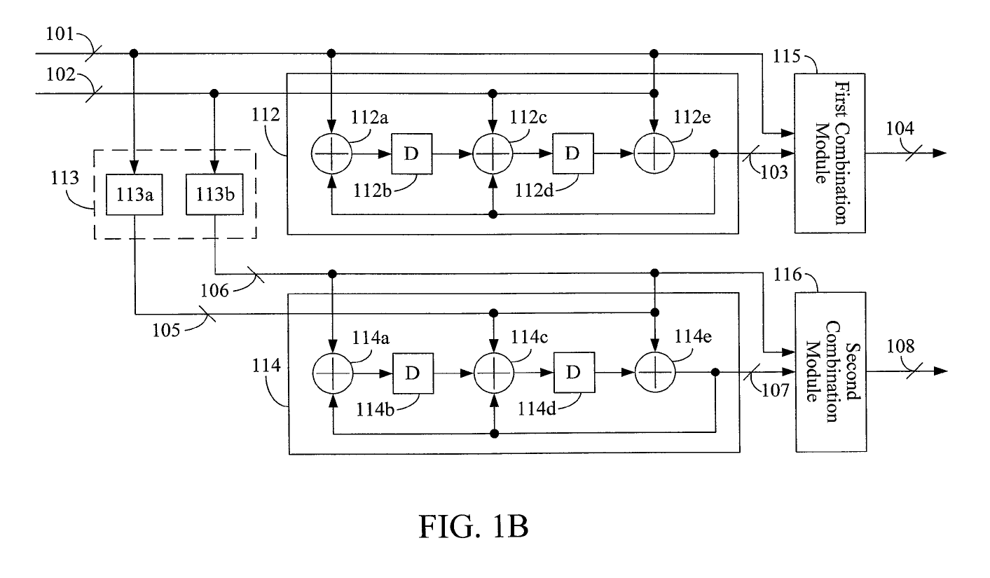

FIG. 1A is a schematic view of a first embodiment of this invention. The first embodiment is a wireless communication system for transmission 10, which adopts Tone-Interleaved Coded Modulation (TICM).

The wireless communication system for transmission 10 comprises a processor 11, a first Quadrature Amplitude Modulation (QAM) mapper 12a, a second QAM 12b, a tone-level interleaver 13, a parser 14, an Inverse Fast Fourier Transformer 15 and a transmission apparatus 16. The processor 11 comprises a division module 111, a first logic operation module 112, an interleaving module 113, a second logic operation module 114, a first combination module 115, and a second combination module 116. The processor 11 is configured to encode a plurality of information bits into a plurality of transmitted signals, while the first QAM mapper 12a, the second QAM mapper 12b, the tone-level interleaver 13, the parser 14, and the inverse Fast Fourier transformer 15 are configured to perform subsequent processing on the transmitted signals for transmission from the transmission apparatus 16. Hereinafter, how the system operates will be described in detail.

Upon receiving a plurality of information bits 100, the division module 111 of the processor 11 divides the information bits 100 into a first part 101 and a second part 102. Assuming that there are n information bits in total, the division module 111 assigns the first n/2 information bits as the first part 101 and the second n/2 information bits as the second part 102. In other implementations, the division module 111 may divide the information bits 100 in other ways. That is, the way that the division module 111 divides the information bits 100 is not intended to limit the scope of this invention.

Referring to FIG. 1B together, which illustrates a detailed partial view of the processor 1. The first logic operation module 112 comprises two delay units 112b, 112d and three exclusive OR (XOR) gates 112a, 112b, 112c, and the connections among which are as shown in FIG. 1B. The second logic operation module 114 comprises two delay units 114b, 114d and three XOR gates 114a, 114b, 114c, and the connections among which are as also shown in FIG. 1B. The interleaving module 113 comprises a first interleaving element 13a and a second interleaving element 113b. In other implementations, the first logic operation module 112 and the second logic operation module 114 may comprise more delay units and XOR gates in order to achieve the same objectives.

After the information bits 100 have been divided into the first part 101 and the second part 102, the first logic operation module 112 applies a logic operation to the first part 101 and the second part 102 of the information bits. That is, the first logic operation module 112 routes the first part 101 and the second part 102 of the information bits through the delay units 112b, 112d and the XOR gates 112a, 112b, 112c to obtain a first encoded signal 103. Then, the first combination module 115 combines the first part 101 and the first encoded signal 103 to obtain one 104 of the transmitted signals (referred to as the first transmitted signal 104 hereinafter). In particular, the first combination module 115 combines the first part 101 and the first encoded signal 103 by alternately outputting one bit, and the first transmitted signal 104 is obtained accordingly.

On the other hand, the interleaving module 113 utilizes the first interleaving element 113a to interleave the first part 101 of the information bits to obtain a first interleaved sub-signal 105, and utilizes the second interleaving element 113b to interleave the second part 102 of the information bits to obtain a second interleaved sub-signal 106. In other implementations, the interleaving module 113 may be provided with only a single interleaving element, which is configured to interleave the first part 101 and the second part 102 of the information bits respectively.

Subsequently, the second logic operation module 114 applies a logic operation to the first interleaved sub-signal 105 and the second interleaved signal 106. That is, the second logic operation module 114 routes the first interleaved sub-signal 105 and the second interleaved signal 106 through the delay units 114b, 114d and the XOR gates 114a, 114b, 114c to obtain a second encoded signal 107. Then, the second combination module 116 combines the second interleaved sub-signal 106 and the second encoded signal 107 to obtain another one 108 of the transmitted signals (referred to as the second transmitted signal 108 hereinafter). In particular, the second combination module 116 combines the second interleaved sub-signal 106 and the second encoded signal 107 by alternately outputting one bit, and the second transmitted signal 108 is obtained accordingly.

Upon the generation of the first transmitted signal 104 and the second transmitted signal 108, the first QAM mapper 12a and the second QAM mapper 12b map the first transmitted signals 104 and the second transmitted signal 108 by QAM to obtain a first QAM symbol and a second QAM symbol respectively. Then, the tone-level interleaver 13 interleaves the first QAM symbol and the second QAM symbol to obtain an interleaved resultant signal. Subsequently, the parser 14 parses the interleaved resultant signal according to the number of transmission interfaces included in the transmission apparatus 16. For example, if the transmission apparatus 16 includes two transmission interfaces, the parser 14 parses the interleaved resultant signal into a first parsed signal and a second parsed signal. Thereafter, the inverse fast Fourier transformer 15 applies Inverse Fast Fourier Transform (IFFT) to the first parsed signal and the second parsed signal respectively, which are then transmitted from the transmission apparatus 16. The above first QAM mapper 12a, the second QAM mapper 12b, the tone-level interleaver 13, the parser 14, the inverse fast Fourier transformer 15 and the transmission apparatus are well known in the art and thus will not be described in detail herein.

In the wireless communication system for transmission 10 of this embodiment, the processor 11 encodes the information bits 100 into two transmitted signals 104, 108 in the particular way described above, and then the first QAM mapper 12a, the second QAM mapper 12b, the tone-level interleaver 13, the parser 14, the inverse fast Fourier transformer 15, and the transmission apparatus 16 perform subsequent processes. In contrast with the prior arts that directly process information bits in a single path, the processor 11 of this embodiment firstly divides the information bits into the first part 101 and the second part 102 and then applies the interleaving and logic operations to the first part 101 and the second part 102 so as to form the two transmitted signals 104, 108 respectively. Therefore, occurrence of bursty bit errors will be reduced during decoding operations.

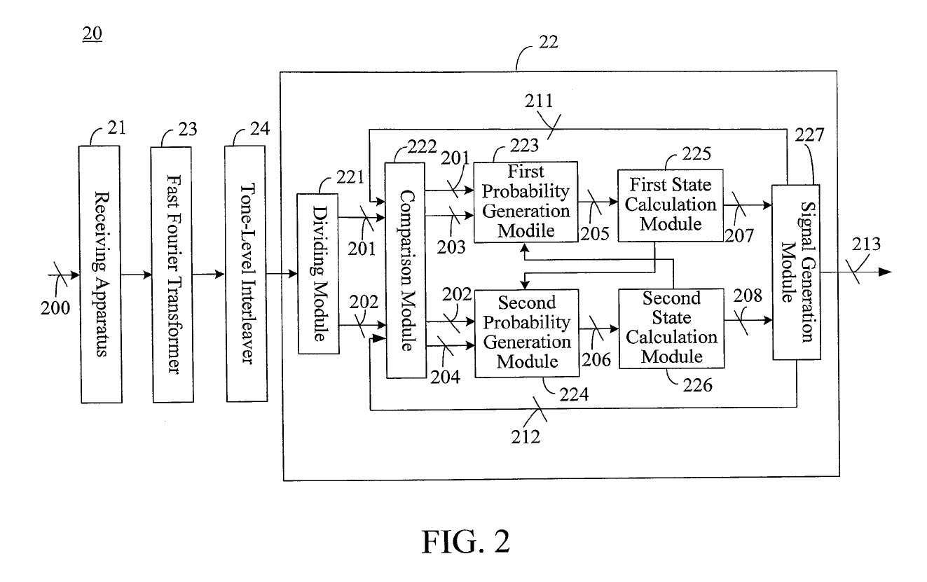

FIG. 2 is a schematic view of a second embodiment of this invention. The second embodiment is a wireless communication system for receiving 20 adopting TICM. The wireless communication system for receiving 20 comprises a receiving apparatus 21, a fast Fourier transformer 23, a tone-level de-interleaver 24, and a processor 22.

The processor 22 comprises a division module 221, a comparison module 222, a first probability generation module 223, a second probability generation module 224, a first state calculation module 225, a second state calculation module 226, a signal generation module 227, and a combination module 228. How this system operates will be described in details in the following paragraphs.

After the receiving apparatus 21 receives a wireless signal and before the wireless signal is sent to the processor 22, the fast Fourier transformer 23 applies Fast Fourier Transform (FFT) to the wireless signal to obtain a transformed signal. Next, the tone-level de-interleaver 24 de-interleaves the transformed signal to obtain a received signal 200, and the received signal 200 is then transmitted to the processor 22. Since this is well known in the art and falls outside of the scope of this invention, it is not detailed herein.

After the processor 22 receives the received signal 200, the division module 221 divides the received signal 200 into a first sub-signal 201 and a second sub-signal 202. In particular, assuming that the received signal 200 contains n information bits in total, the division module 221 assigns the first n/2 information bits as the first sub-signal 201 and the second n/2 information bits as the second sub-signal 202. Here, the division module 221 divides the information bits in a manner corresponding to that used by the division module 111 of the first embodiment. In other words, in case the division module 111 of the wireless communication system for transmission 10 changes the dividing manner, the division module 221 shall changes the dividing manner accordingly. The first sub-signal 201 has a plurality of first candidate values, and the second sub-signal 202 has a plurality of second candidate values. Here, the first sub-signal and the second sub-signal correspond to the two transmitted signals of the first embodiment.

Next, the comparison module 222 decides the first candidate values 203 by comparing the first sub-signal 201 with a reference value, and decides the second candidate values 204 by comparing the second sub-signal 202 with the reference value. The reference value is generated from a previous comparison result, which will be described in detail later.

Specifically, since it is impossible for the wireless communication system for receiving 20 to learn the corresponding transmitted signal when it receives a received signal (i.e., a number of candidate values corresponding to the transmitted signal exist for the received signal), the comparison module 222 may filter to derive the candidate values with higher probabilities so as to reduce the number of candidate values as well as decrease computational complexity of the system. However, in other implementations, the comparison module 222 may be omitted if the computational complexity is not the considered issue.

The first probability generation module 223 generates a first candidate probability value 205 for each of the first candidate values 203 according to the first sub-signal 201. On the other hand, the second probability generation module 224 generates a second candidate probability value 206 for each of the second candidate values 204 according to the second sub-signal 202.

Specifically, after the comparison module 222 decides the first candidate values 203 that correspond to the first sub-signal 201 and the second candidate values 204 that correspond the second sub-signal 202, the first probability generation module 223 calculates the probabilities that the transmitted signals correspond to each of the first candidate values 203 (i.e., the first candidate probability values) for the first sub-signal 201 and the second probability generation module 224 calculates the probabilities that the transmitted signals correspond to each of the second candidate values 203 (i.e., the second candidate probability values) for the second sub-signal 202.

Subsequently, the first state calculation module 225 calculates a plurality of first state probability values and a plurality of first state transition probability values 207 according to the first candidate probability values 205. Similarly, the second state calculation module 226 calculates a plurality of second state probability values and a plurality of second state transition probability values 208 according to the second candidate probability values 206.

Specifically, since the wireless communication system for receiving 20 adopts the TICM architecture, a signal is transmitted in units of symbols rather than in units of bits, i.e., the transmitted symbols are in a form of consecutive bits, and all the symbols forms a trellis structure. Hence, the first state calculation module 225 and the second state calculation module 226 may calculate the first state probability values according to the trellis structure as well as the first candidate probability values and the second candidate probability values of the transmitted signals corresponding to the received signal, and further calculate the first state transition probability values according to the first state probability values. Similarly, the second state calculation module 226 calculates the second state probability values according to the trellis structure.

Afterwards, the signal generation module 227 generates a first sub-resultant signal according to the first state probability values and the first state transition probability values 207, and generates a second sub-resultant signal according to the second state probability values and the second state transition probability values 208. Finally, the first sub-resultant signal and the second sub-resultant signal are combined to generate the information bits 211.

Specifically, the signal generation module 227 determines probabilities for each of the bits in the signal to be 0 or 1 according to the first state probability values and the first state transition probability values 207, and generates the first sub-resultant signal by taking the binary value with the higher probability as the value of the bit. Likewise, the signal generation module 227 determines probabilities for each of the bits in the signal to be 0 or 1 according to the second state probability values and the second state transition probability values 208, and generates the second sub-resultant signal 210 by taking the binary value with the higher probability as the value of the bit.

In the following description, feedback routes of the second embodiment will be described. There are two feedback routes: the first one is from the signal generation module 227 to the comparison module 222, and the second one is from the first state calculation module 225 to the second probability generation module 224 and from the second state calculation module 226 to the first probability generation module 223 respectively.

The feedback route from the signal generation module 227 to the comparison module 222 is described first. The signal generation module 227 further generates a first encoded information 211 according to the first state probability values and the first state transition probability values 207, and generates a second encoded information 212 according to the second state probability values and the second state transition probability values 208. The first encoded information 211 and the second encoded information 212 are then fed back to the comparison module 222. By doing so, the comparison module 222 will utilize the first encoded information 211 to decide the first candidate values 203 during a next comparison of the first sub-signal with the reference value and utilize the second encoded information 212 to decide the second candidate values 204 during a next comparison of the second sub-signal with the reference value. In some implementations, the first encoded information 211 and the second encoded information 212 may be set directly as the previously described reference values used by the comparison module 222 for deciding the first candidate values 203 and the second candidate values 204.

In more detail, the first encoded information 211 and the second encoded information 212 correspond to the first encoded signal 103 and the second encoded signal 107 in the transmitted signals of the first embodiment respectively. Therefore, if the previous first encoded information 211 and the previous second encoded information 212 can be obtained, then more accurate candidate values will be resulted when the comparison module 222 decides the first candidate values 203 and the second candidate values 204.

Hence, during operations of the wireless communication system for receiving 20, the signal generation module 227 continuously generates the first encoded information according to the previous first state probability values and a plurality of previous first state transition probability values, and continuously generates the second encoded information according to the previous second state probability values and a plurality of previous second state transition probability values. The first encoded information and the second encoded information are then fed back to the comparison module 222 to improve accuracy of each operation.

Next, description is made on the feedback route from the first state calculation module 225 to the second probability generation module 224 and from the second state calculation module 226 to the first probability generation module 223 respectively. Similarly, the first probability generation module 223 generates the first candidate probability values 205 according to the previous second state probability values and the previous second state transition probability values 208, and the second probability generation module 224 generates the second candidate probability values 206 according to the previous first state probability values and the previous first state transition probability values 207. In this way, the resulting candidate probability values will be rendered more accurate.

When the wireless communication system for transmission 10 of the first embodiment is used in combination with the wireless communication system for receiving 20 of the second embodiment, the processor 11 of the wireless communication system for transmission 10 encodes the information bits twice to generate two transmitted signals on the one hand, and the processor 22 of the wireless communication system for receiving 20 generates information bits corresponding to the received signal by deciding candidate values and calculating candidate probability values, state probability values, and state transition probability values. As a result, occurrence of bursty bit errors is reduced, and the performance of the system is improved.

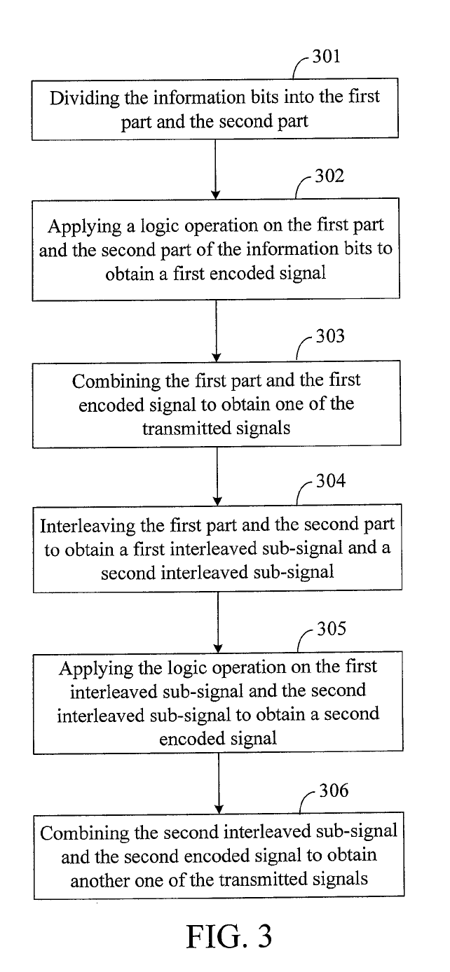

A third embodiment of this invention is a method for encoding a plurality of information bits into a plurality of transmitted signals, and a flow chart of which is depicted in FIG. 3. This method is adapted for the aforesaid wireless communication system for transmission 10. Initially in step 301 is executed to divide the information bits into the first part 101 and the second part 102. Then, in step 302, the first logic operation module 112 applies a logic operation to the first part 101 and the second part 112 of the information bits to obtain a first encoded signal 103, wherein the logic operation comprises at least two delay operations. Next in step 303 is executed to combine the first part 101 and the first encoded signal 103 to obtain one of the transmitted signals 104.

Subsequently, step 304 is executed to interleave the first part 101 and the second part 102 to obtain a first interleaved sub-signal 105 and a second interleaved sub-signal 106. Then in step 305, the second logic operation module 114 applies the logic operation to the first interleaved sub-signal 105 and the second interleaved sub-signal 106 to obtain a second encoded signal 107. Similarly, the logic operation comprises at least two delay operations. Finally, in step 306, the combination module 115 combines the second interleaved sub-signal 106 and the second encoded signal 107 to obtain another one of the transmitted signals 108.

It should be emphasized that, this method is not merely limited to the execution sequence described above, and other sequences may also be possible as long as step 304 comes after step 301, step 302 comes after step 301, step 303 comes after step 302, step 305 comes after step 304, and step 306 comes after step 305. In other words, execution times of steps 304, 305 306 and execution times of steps 302, 303 may overlap.

In addition to the aforementioned steps, the third embodiment is also capable of executing all the operations and functionalities described in the first embodiment. Those of ordinary skill in the art may readily appreciate how the third embodiment executes these operations and functionalities based on description of the first embodiment, and thus this will not be further described in detail.

According to the method for encoding a plurality of information bits into a plurality of transmitted signals of this embodiment, encoded signals are generated by logic operations, and then used to encode the information bits into two transmitted signals. As the two transmitted signals both have encoded signals, occurrence of bursty bit errors will be reduced during the decoding operation.

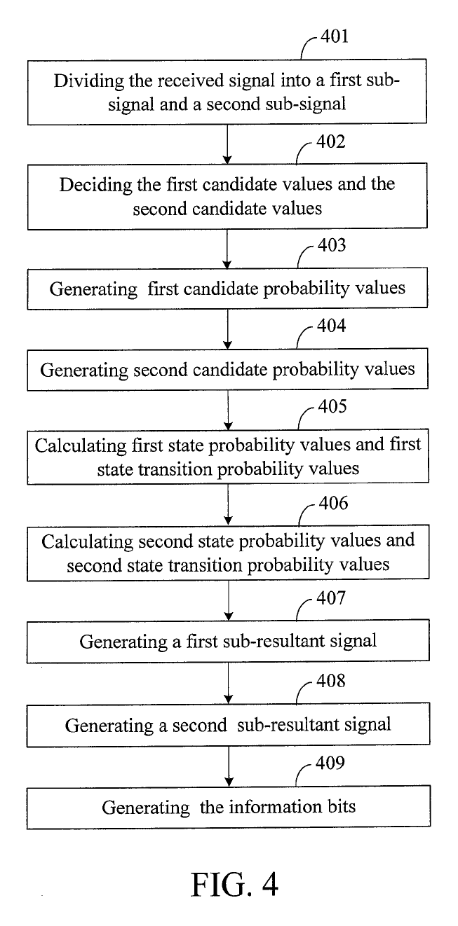

A fourth embodiment of this invention is a method for decoding a received signal into a plurality of information bits, and a flow chart of which is depicted in FIG. 4. This method is adapted for the aforesaid wireless communication system for receiving 20. Initially in step 401, the received signal is divided into a first sub-signal 201 having a plurality of first candidate values and a second sub-signal 202 having a plurality of second candidate values. Then in step 402, the first candidate values 203 are decided by comparing the first sub-signal 201 with a reference value, and the second candidate values 204 are decided by comparing the second sub-signal 202 with the reference value. Details thereof are just the same as described in the second embodiment and thus will not be described again herein.

Next in step 403, a first candidate probability value 205 is generated for each of the first candidate values 203 according to the first sub-signal 201; similarly in step 404, a second candidate probability value 206 is generated for each of the second candidate values 204 according to the second sub-signal 202. Details thereof are just the same as described in the second embodiment and thus will not be described again herein. However, it should be emphasized that, in other implementations, step 404 may be executed before or simultaneously with step 403.

Subsequently in step 405, a plurality of first state probability values and a plurality of first state transition probability values 207 are calculated according to the first candidate probability values 205; similarly in step 406, a plurality of second state probability values and a plurality of second state transition probability values 208 are calculated according to the second candidate probability values 206. Details thereof are just the same as described in the second embodiment and thus will not be described again herein. However, it should be emphasized that, in other implementations, step 406 may be executed before or simultaneously with step 405.

Next, a first sub-resultant signal 209 is generated according to the first state probability values and the first state transition probability values 207 in step 407, and a second sub-resultant signal 210 is generated according to the second state probability values and the second state transition probability values 208 in step 408. In other implementations, step 408 may be executed before or simultaneously with step 407.

Finally in step 409, the first sub-resultant signal 209 and the second sub-resultant signal 210 are combined to generate the information bits 211. Details thereof are just the same as described in the second embodiment and thus will not be described again herein.

In addition to the aforementioned steps, the fourth embodiment is also capable of executing all the operations and functionalities described in the second embodiment. Those of ordinary skill in the art may readily appreciate how the fourth embodiment executes these operations and functionalities based on description of the second embodiment, and thus this will not be further described in detail.

By using the method of encoding information bits into transmitted signals of the third embodiment in combination with the method of decoding a received signal into information bits of the fourth embodiment, the information bits are encoded into two transmitted signals during the encoding operation on one hand, and the information bits are generated by deciding candidate values and calculating candidate probability values, state probability values and state transition probability values when decoding a received signal on the other hand. As a result, information bits generated by this method are less susceptible to bursty bit errors.

In summary, this invention provides a wireless communication system for transmission and an apparatus and a method of encoding a plurality of information bits into a plurality of transmitted signals thereof, and a wireless communication system for receiving and a method of decoding a receiving signal into a plurality of information bits thereof. By replacing the conventional TICM encoding and decoding processors with the encoding and decoding processors of this invention, susceptibility to bursty bit errors in case of a long channel response can be obviated, thus effectively overcoming the shortcoming of TICM wireless communication systems.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for encoding a plurality of information bits to a plurality of transmitted signals, comprising the steps of:
applying a logic operation to a first part of the information bits and a second part of the information bits to obtain a first encoded signal;
combining the first part and the first encoded signal to obtain one of the transmitted signals;
interleaving the first part and the second part to obtain a first interleaved sub-signal and a second interleaved sub-signal;
applying the logic operation to the first interleaved sub-signal and the second interleaved sub-signal to obtain a second encoded signal; and
combining the second interleaved sub-signal and the second encoded signal to obtain another of the transmitted signals.

2. The method of claim 1, further comprising the step of:
dividing the information bits into the first part and the second part.

3. The method of claim 1, wherein the logic operation comprises at least two delay operations.

4. A method for decoding a received signal into a plurality of information bits, comprising the steps of:
(a) dividing the received signal into a first sub-signal and a second sub-signal, the first sub-signal having a plurality of first candidate values, and the second sub-signal having a plurality of second candidate values;
(b) generating a first candidate probability value for each of the first candidate values according to the first sub-signal;
(c) generating a second candidate probability value for each of the second candidate values according to the second sub-signal;
(d) calculating a plurality of first state probability values and a plurality of first state transition probability values according to the first candidate probability values;
(e) calculating a plurality of second state probability values and a plurality of second state transition probability values according to the second candidate probability values;
(f) generating a first sub-resultant signal according to the first state probability values and the first state transition probability values;
(g) generating a second sub-resultant signal according to the second state probability values and the second state transition probability values;
(h) combining the first sub-resultant signal and the second sub-resultant signal to generate the information bits.

5. The method of claim 4, wherein the step (b) further utilizes a plurality of previous second state probability values and a plurality of previous second state transition probability values to generate the first candidate probability value.

6. The method of claim 4, wherein the step (c) further utilizes a plurality of previous first state probability values and a plurality of previous first state transition probability values to generate the second candidate probability value.

7. The method of claim 4, further comprising the steps of:
(i) deciding the first candidate values by comparing the first sub-signal with a reference value; and
(j) deciding the second candidate values by comparing the second sub-signal with the reference value.

8. The method of claim 7, further comprising the steps of:
generating a first encoded information according to a plurality of previous first state probability values and a plurality of previous first state transition probability values; and
generating a second encoded information according to a plurality of previous second state probability values and a plurality of previous second state transition probability values;
wherein the step (i) further utilizes the first encoded information to decide the first candidate values and the step (j) further utilizes the second encoded information to decide the second candidate values.

9. An apparatus for encoding a plurality of information bits to a plurality of transmitted signals, comprising:
a first logic operation module, configured for applying a logic operation to a first part of the information bits and a second part of the information bits to obtain a first encoded signal;
an interleaving module, configured for interleaving the first part and the second part to obtain a first interleaved sub-signal and a second interleaved sub-signal;
a second logic operation module, configured for applying the logic operation to the first interleaved sub-signal and the second interleaved sub-signal to obtain a second encoded signal;
a first combination module, configured for combining the first part and the first encoded signal to obtain one of the transmitted signals; and
a second combination module, configured for combining the second interleaved sub-signal and the second encoded signal to obtain another of the transmitted signals.

10. The apparatus of claim 9, further comprising:
a division module, configured for dividing the information bits into the first part and the second part.

11. The apparatus of claim 9, wherein the logic operation comprises at least two delay operations.

12. An apparatus for decoding a received signal into a plurality of information bits, comprising:
a division module, configured for dividing the received signal into a first sub-signal and a second sub-signal, the first sub-signal having a plurality of first candidate values, and the second sub-signal having a plurality of second candidate values;
a first probability generation module, configured for generating a first candidate probability value for each of the first candidate values according to the first sub-signal;
a second probability generation module, configured for generating a second candidate probability value for each of the second candidate values according to the second sub-signal;
a first state calculation module, configured for calculating a plurality of first state probability values and a plurality of first state transition probability values according to the first candidate probability values;
a second state calculation module, configured for calculating a plurality of second state probability values and a plurality of second state transition probability values according to the second candidate probability values; and
a signal generation module, configured for generating a first sub-resultant signal according to the first state probability values and the first state transition probability values, generating a second sub-resultant signal according to the second state probability values and the second state transition probability values, and combining the first sub-resultant signal and the second sub-resultant signal to generate the information bits.

13. The apparatus of claim 12, wherein the first probability generation module further utilizes a plurality of previous second state probability values and a plurality of previous second state transition probability values to generate the first candidate probability value, and the second probability generation module further utilizes a plurality of previous first state probability values and a plurality of previous first state transition probability values to generate the second candidate probability value.

14. The apparatus of claim 12, further comprising:
a comparison module, configured for deciding the first candidate values by comparing the first sub-signal with a reference value, and deciding the second candidate values by comparing the second sub-signal with the reference value.

15. The apparatus of claim 12, wherein the signal generation module is further configured for generating a first encoded information according to a plurality of previous first state probability values and a plurality of previous first state transition probability values and generating a second encoded information according to a plurality of previous second state probability values and a plurality of previous second state transition probability values, and the comparison module is further configured for utilizing the first encoded information to decide the first candidate values and utilizing the second encoded information to decide the second candidate values.

16. A wireless communication system for transmission, comprising:
a processor, configured for applying a logic operation to a first part of information bits and a second part of the information bits to obtain a first encoded signal, for interleaving the first part and the second part to obtain a first interleaved sub-signal and a second interleaved sub-signal, for applying the logic operation on the first interleaved sub-signal and the second interleaved sub-signal to obtain a second encoded signal, for combining the first part and the first encoded signal to obtain a first transmitted signal of a plurality of transmitted signals, and for combining the second interleaved sub-signal and the second encoded signal to obtain a second transmitted signal of the transmitted signals;
a first Quadrature Amplitude Modulation (QAM) mapper, configured for mapping the first transmitted signal by QAM to obtain a first QAM symbol;
a second QAM mapper, configured for mapping the second transmitted signal by QAM to obtain a second QAM symbol;
a tone-level interleaver, configured for interleaving the first QAM symbol and the second QAM symbol to obtain a interleaved resultant signal;
a parser, configured for parsing the interleaved resultant signal to obtain a plurality of sub-parsed resultant signal;
an inverse fast Fourier transformer, configured for applying inverse Fourier transform to each of the sub-parsed resultant signals to obtain a plurality of wireless transmitted signals; and
a transmission apparatus, configured for transmitting the wireless transmitted signals.

17. The wireless communication system of claim 16, wherein the processor is further configured for dividing the information bits into the first part and the second part.

18. The wireless communication system of claim 16, wherein the logical operation comprises at least two delay operations.

19. A wireless communication system for receiving, comprising:
a receiving apparatus, configured for receiving a wireless signal;
a fast Fourier transformer, configured for applying fast Fourier transform to the wireless signal to obtain a transformed signal;
a tone-level de-interleaver, configured for de-interleaving the transformed signal to obtain a received signal; and
a processor, configured for dividing the received signal to a first sub-signal and a second sub-signal, the first sub-signal having a plurality of first candidate values, the second sub-signal having a plurality of second candidate values, configured for generating a first candidate probability value for each of the first candidate values according to the first sub-signal, configured for generating a second candidate probability value for each of the second candidate values according to the second sub-signal, configured for calculating a plurality of first state probability values and a plurality of first state transition probability values according to the first candidate probability values, configured for calculating a plurality of second state probability values and a plurality of second state transition probability values according to the second candidate probability values, configured for generating a first sub-resultant signal according to the first state probability values and the first state transition probability values, configured for generating a second sub-resultant signal according to the second state probability values and the second state transition probability values, and configured for combining the first sub-resultant signal and the second sub-resultant signal to generate the information bits.

20. The wireless communication system of claim 19, wherein the processor further utilizes a plurality of previous second state probability values and a plurality of previous second state transition probability values to generate the first candidate probability value, and the processor further utilizes a plurality of previous first state probability values and a plurality of previous first state transition probability values to generate the second candidate probability value.

21. The wireless communication system of claim 19, wherein the processor is further configured for deciding the first candidate values by comparing the first sub-signal with a reference value, and deciding the second candidate values by comparing the second sub-signal with the reference value.

22. The wireless communication system of claim 19, wherein the processor is further configured for generating a first encoded information according to a plurality of previous first state probability values and a plurality of previous first state transition probability values, generating a second encoded information according to a plurality of previous second state probability values and a plurality of previous second state transition probability values, deciding the first candidate values according to the first encoded information, and deciding the second candidate values according to the second encoded information.
